(19) United States
(12) Patent Application Publication
(10) Pub. No.: US 2017/0178235 A1
(43) Pub. Date: Jun. 22, 2017

(54) AVOIDING ORDERS THAT CROSS

(71) Applicant: TRADING TECHNOLOGIES INTERNATIONAL INC., CHICAGO, IL (US)

(72) Inventors: Patrick J. Rooney, St. Charles, IL (US); Stephen P. Decker, Naperville, IL (US)

(21) Appl. No.: 14/979,160

(22) Filed: Dec. 22, 2015

(51) Int. Cl. G06Q 40/04; G06Q 40/06

(52) U.S. Cl. CPC G06Q 40/04; G06Q 40/06

(57) ABSTRACT

Systems and methods for avoiding orders that cross are described herein. An example method includes obtaining a first trade order to be communicated to an exchange by a user associated with a trading entity, where the first trade order corresponds to a tradeable object offered at the exchange. The example method includes comparing the first trade order to one or more trade orders in a submission record to determine whether a contra-side second trade order is included in the one or more trade orders of the submission record, where the second trade order was communicated to the exchange by the trading entity. The example method also includes determining when the second trade order is no longer pending at the exchange and communicating the first trade order to the exchange in response to the determination that the second trade is no longer pending at the exchange.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

In some instances, two or more orders that are contra-side or crossing orders may be sent to an exchange from a common trading entity. Contra-side or crossing orders are orders that are associated with the same tradeable object at the same price level where one of the orders is a buy and the other order is a sell. For example, a trading firm may be prohibited from sending a buy order to an exchange for tradeable object ‘X’ at price ‘Y’ and also sending a sell order to the exchange for the same tradeable object ‘X’ at the same price ‘Y.’ To avoid orders that cross, known electronic trading systems typically check to ensure that a trade order has not been sent to an exchange if a contra-side order is pending at the exchange that was previously sent by another trader within the same trading entity. If a contra-side trade order is pending at the exchange, known electronic trading systems either cancel the contra-side trade order that is pending at the exchange or reject/cancel the new trade order.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of an example trading system having an example submission manager for avoiding orders that cross.

FIG. 5 illustrates an example order book or submission record managed by the example submission manager of FIG. 4.

FIG. 6 illustrates an example auxiliary queue for trade orders that are held by the example submission manager of FIG. 4.

FIG. 7 illustrates a flowchart representative of an example method for avoiding orders that cross and which may be implemented by the example trading system of FIG. 4.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading systems and, more specifically, to electronic trading systems and method for avoiding orders that cross.

As used herein, contra-side or crossing orders refer to two trade orders for the same tradeable object: one being an order to buy the tradeable object a particular price and the other being an order to sell the same tradeable object at the same price. If communicated to an exchange, contra-side orders may fill or complete each other. It is advantageous to avoid sending a trade order to an exchange where a contra-side order sent from the same trading entity already exists (e.g., is pending, resting or working at the exchange). A trading entity may be a trading firm or financial institution, a trading group (having one or more traders) within a trading firm or financial institution, one or more traders and/or accounts, and/or any other combination of traders and/or accounts sharing a common order book. In practice, a trading entity desires to avoid sending a trade order to the exchange when a potentially crossing trade order from the same trading entity currently exists.

The example systems and methods disclosed herein may be employed to avoid orders that cross. In general, the example systems and methods employ a submission manager, which may be implemented by a pre-trade risk module, to determine if a new trade order has a contra-side trade order already pending or resting at the exchange from the same trading entity. The submission manager compares the new trade order to a submission record or order book that contains a listing of all the orders submitted and pending at the exchange. If a contra-side trade order is detected in the order book, the new trade order is not communicated to the exchange. Instead, the new trade order is held, temporarily, until the contra-side trade order is no longer pending at the exchange (e.g., because the contra-side order fills, is cancelled or modified to a different price level). In some examples, the submission manager periodically (e.g., based on a timer) checks to determine if the contra-side order is still pending at the exchange. Additionally or alternatively, in some examples the submission manager determines the contra-side trade order is no longer pending at the exchange based on a fill message received from the exchange. The fill message may indicate the contra-side order has been filled and, thus, is no longer pending at the exchange. Once the contra-side order is no longer pending at the exchange, the submission manager communicates the new trade order to the exchange. As a result, the contra-side trade order from the same trading entity is not pending at the exchange and, thus, crossing at the exchange is avoided.

In some examples, when a contra-side trade order is detected at the exchange and a new trade order is held (e.g., via the submission manger), the new trade order is placed in an auxiliary queue. The auxiliary queue may include one or more other orders that are similarly held and waiting to be communicated. For example, there may be multiple trade orders for the same tradeable object that are held by the submission manager. In some examples, the trade orders in the queue are prioritized, such that when the contra-side trade order is no long pending, the top trade order in the queue may be sent first, before the other trade orders in the queue are communicated. The trade orders in the queue may be prioritized based on time received, a respective trader, size of quantity and/or any other factor that may distinguish two trade orders.

In the past, where traders met and traded in a pit, the problem of crossing orders did not exist. Each individual trader was aware of the pending orders that the respective trader was offering. However, with current electronic trading systems/networks, the amount of trades and operation of trading has changed dramatically. For example, one trader from a trading firm may place an order via his/her mobile phone in one city, while another trade from the same trading firm may place and order via his/her computer in another city. A trading entity may include hundreds or thousands of traders, each placing multiple trades a day. With such a large volume of transactions, spanning across many areas and devices, the problem of crossing orders arose. The example electronic systems and methods disclosed herein prevent crossing orders from being sent to an exchange by the same trading entity (and thereby reducing the risk of any legal ramifications) while still addressing the traders desire to quickly and efficiently send orders to an exchange.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide a method including obtaining, via a submission manager, a first trade order to be communicated to an exchange by a user associated with a trading entity. The first trade order corresponds to a tradeable object offered at the exchange. The example method includes comparing, via the submission manager, the first trade order to one or more trade orders in a submission record to determine whether a contra-side second trade order is included in the one or more trade orders of the submission record. The second trade order was communicated to the exchange by the trading entity. The example method also includes determining, via the submission manager, when the second trade order is no longer pending at the exchange and communicating, via the submission manager, the first trade order to the exchange in response to the determination that the second trade is no longer pending at the exchange.

Certain embodiments provide a system including a computing device configured to obtain a first trade order to be communicated to an exchange by a user associated with a trading entity. The first trade order corresponds to a tradeable object offered at the exchange. The computing device of the example system is configured to compare the first trade order to one or more trade orders in a submission record to determine whether a contra-side second trade order is included in the one or more trade orders of the submission record. The second trade order was communicated to the exchange by the trading entity. The computing device of the example system is further configured to determine when the second trade order is no longer pending at the exchange and communicate the first trade order to the exchange in response to the determination that the second trade is no longer pending at the exchange.

Certain embodiments provide a tangible computer readable storage device including instructions that, when executed, cause a computing device to at least obtain a first trade order to be communicated to an exchange by a user associated with a trading entity. The first trade order corresponds to a tradeable object offered at the exchange. The instructions cause the computing device to compare the first trade order to one or more trade orders in a submission record to determine whether a contra-side second trade order is included in the one or more trade orders of the submission record. The second trade order was communicated to the exchange by the trading entity. The instructions also cause the computing device to determine when the second trade order is no longer pending at the exchange and communicate the first trade order to the exchange in response to the determination that the second trade is no longer pending at the exchange.

### II. Example Electronic Trading System

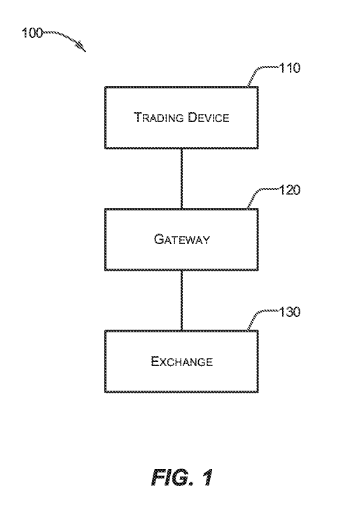

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET∩ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

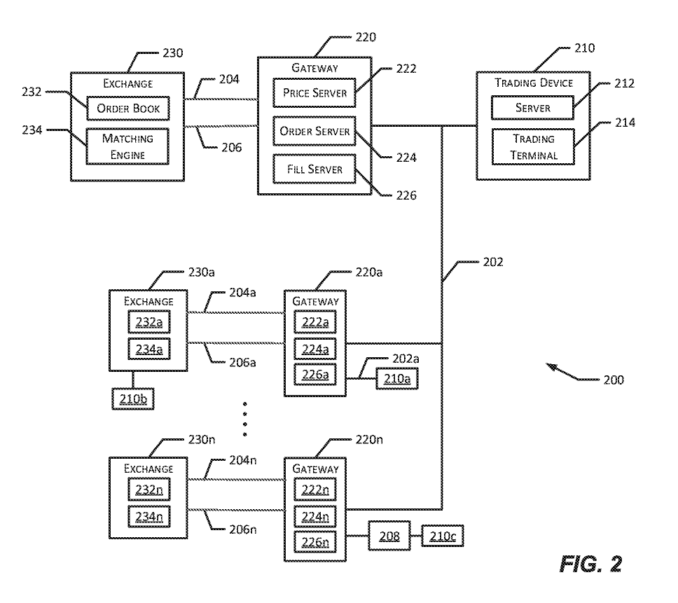

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

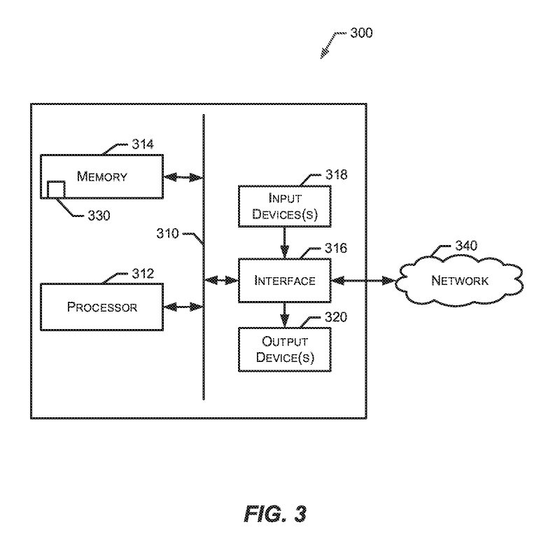

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Avoiding Orders That Cross

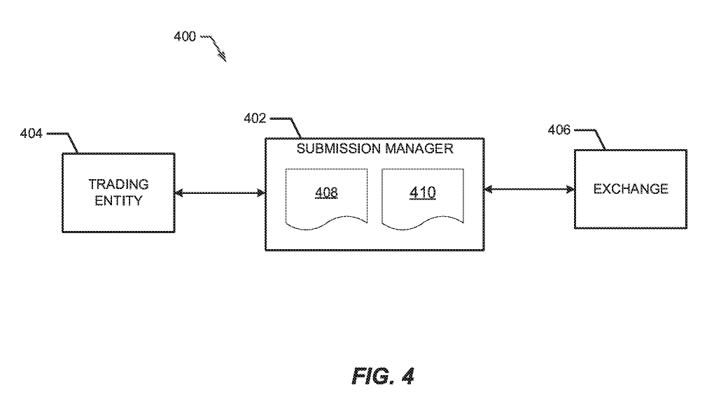

FIG. 4 illustrates an example trading system 400 in which certain embodiments may be employed. The system 400 includes an example submission manager 402 that interfaces between a trading entity 404 and an exchange 406. The trading entity 404 may correspond to the one or more trading devices 110, 210 of FIGS. 1 and 2 and the exchange 406 may correspond to the exchange 130, 230 of the FIGS. 1 and 2. The trading entity 404 represents one or more traders and/or accounts that share a common order book. The trading entity 404 may be an individual trader or multiple traders within the same trading group or financial institution.

The submission manager 402 obtains or receives trade orders sent from the trading entity 404 to the exchange 406. The trade orders are recorded in an order book 408 (e.g., a submission record). FIG. 5 illustrates an example of the order book 408 having a plurality of trade orders. The order book 408 may be displayed via a trading application and/or trading tool. In the illustrated example, the order book 408 includes a plurality of columns with identifying information for each of the trade orders. For example, the order book 408 includes a date column 500 that includes the date the respective trade order was submitted, a time column 502 that includes the time the respective trade order was submitted, a buy/sell column 504 that indicates whether the order is for a buy (“B”) or sell (“S”), a quantity column 506 that includes the quantity of the respective tradeable object, an exchange column 508 that includes the exchange (e.g., CME Group, London International Financial, etc.), a contract name column 510 that includes the name of the contract (e.g., the tradeable object), a price column 512 that includes the price per unit of the tradeable object, an account column 514 that includes the account under which the trade order is sent, an order type column 516 that includes the type of trade order (e.g., limit, market, etc.), a status column 518 that includes the status of the respective trade order (e.g., filled, working, etc.), an originator column 520 that includes the name of the trader or user that submitted the respective trade order and an order identification column 520 that includes the order identification number for the respective trade order. The example order book 408 may include more or few columns of identifying information for the recorded trade orders.

In an example operation, the submission manager 402 receives a new trade order to be sent to the exchange 406 from the trading entity 404. The submission manager 402 determines if a contra-side trade order is already pending (e.g., working or resting and not filled or cancelled) at the exchange 406 that was also sent from the same trading entity 404. For example, as shown in the top row of the order book 408 in FIG. 5, a buy order at a price of 2100.75, for the contract “ES Sep15” is “working” (e.g., pending or trying to be filled) at the exchange 406. If, for example, a subsequent trade order obtained by the submission manager 402 is a sell order for the same contract “ES Sep15” at the same price, 2100.75, the submission manager 402 determines a contra-side trade order exists (i.e., the buy order) and does not submit or allow the new trade order to be communicated to the exchange 406. The submission manager 402 prevents the new trade order from being communicated to the exchange 406 so that the new trade order and the contra-side trade order are not co-pending at the exchange 406. The operation and functionality of the submission manager 402 may be further understood with reference to co-pending U.S. patent application Ser. No. 14/819,019, filed on Aug. 5, 2015 and entitled “Methods and Apparatus to Internalize Trade Orders.” The disclosure of this patent document is hereby incorporated by reference in its entirety.

In some examples, the new trade order is recorded in the order book 408 and given a status to indicate the trade order is waiting (e.g., “waiting,” “waiting to clear,” “waiting for cross to clear,” etc.). In other examples, the new trade order may be recorded in a separate book or queue. Once the contra-side trade order (e.g., the order in the first row of FIG. 5) is not pending at the exchange, the submission manager 402 communicates or sends the new trade order to the exchange 406, thereby avoiding a potential cross at the exchange 406. The contra-side trade order may be no longer pending at the exchange because it was filled, cancelled or modified (e.g., the price was changed) and, thus, is no longer a contra-side or crossing order.

In some examples, to determine if a contra-side trade order is still pending at the exchange 406, the submission manager 402 repeatedly checks the respective price level at a predetermined period of time (e.g., a time interval). For example, every five (5) seconds the submission manager 402 may check to determine if a contra-side trade order is still pending at the exchange 406. The submission manager 402 may repeatedly check the price level at the exchange 406 and/or repeatedly check the order book 408 to determine the status of the contra-side trade order. Additionally or alternatively, the submission manager 402 may wait until a notice or message (e.g., a fill notice, a cancelled notice, etc.) is received from the exchange 406 indicating the contra-side trade order is no longer pending at the exchange 406 (or is no longer a potentially crossing order). For example, if the contra-side trade order is filled, a fill notice is sent back to the trading entity 404 and received by the submission manager 402. The status of the contra-side trade order may be updated in the order book 408 (e.g., “filled”). Once the submission manager 402 determines the contra-side trade order is no longer pending at the exchange 406 (e.g., based on the fill notice and/or updated status in the order book 408), the new trade order that was previously on hold (e.g., waiting) is communicated to the exchange 406.

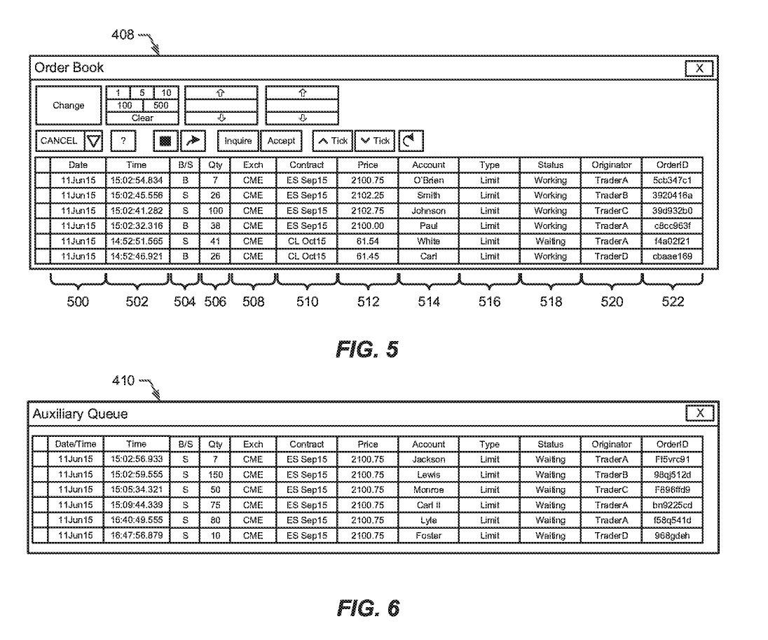

In some examples, more than one trade order for the same tradeable object may be held by the submission manager 402. For example, multiple sell orders may be sent from the same trading entity 404 for the contract “ES Sep15” at the price level 2100.75 while the contra-side trade order (e.g., as shown in the first row of FIG. 5) is still pending at the exchange 406. The submission manager 402 records the sell orders in the order book 410 but does not communicate the sell orders to the exchange 406. In some examples, the waiting trade orders are placed in an auxiliary queue 410 (e.g., a list). FIG. 6 illustrates an example of the auxiliary queue 410, which may be displayed via a trading application and/or trading tool. The auxiliary queue 410 represents a ranking or list of the order in which the trade orders are to be released or communicated to the exchange 406 once the contra-side trade order is no longer pending at the exchange. In the illustrated example, the auxiliary queue 410 includes the same columns of information as the order book 408. As illustrated, the auxiliary queue 410 includes a plurality of trade orders for the same contract “ES Sep15” and at the same price 2100.75. The trade orders may be prioritized based on any factor such as, for example, the date/time when the order was received, the quantity, the trader, etc. For example, if the trade orders in the auxiliary queue 410 are prioritized based on date/time, the trade orders may be communicated based on a first-come-first-send basis. Therefore, the oldest trade order in the auxiliary queue 410 is to be sent first when the contra-side trade order is no longer pending at the exchange 406. As another example, if the trade orders in the auxiliary queue 410 are prioritized based on quantity, the trade order with the highest or lowest quantity may be sent first, prior to the other trade orders in the auxiliary queue 410. In another example, the trade orders of the auxiliary queue 410 may be prioritized based on the trader or user who submitted the respective trade order. In some instances, certain traders or accounts may be superior to other traders or accounts (e.g., based on experience, certification, trading entity standing with the exchange, etc.). As such, the trade orders of the more superior traders or accounts may receive priority over those traders or accounts that are inferior.

In some examples, the auxiliary queue 410 is a separate user interface that may be displayed to the user via a trading application and/or trading tool. In other examples, the submission manager 402 prioritizes the trade orders as the trade orders are recorded in the order book 408. For example, the waiting trade orders in the order book 408 may include a priority status or ranking (e.g., 1, 2, 3, etc.).

In some examples, a contra-side trade order may be defined as any trade order sent from the same trading entity 404 (e.g., in the order book 408) for the same contract at the same price level. However, in other examples, a contra-side trade order may be defined to require matching quantities and/or other criteria. In some examples, crossing may be conditional based on specific traders. For example, a trader may be willing to submit an order that could cross with a contra-side trade order sent by trader X but is unwilling to submit a trade order that would cross with a contra-side order as sent by trader Y. Trader X may have more experience than trader Y, for example, or trader Y may be trading in one lots whereas trader X is trading blocks. As such, the trader may prefer to avoid crossing with trader Y but not with trader X. In such an example, the submission manager 402 may compare a new trade order to the trade orders in the order book 408 to determine if a contra-side trade order is listed in the order book 408 that has been sent by trader Y. If so, the submission manager 402 may prevent the new trade order from being sent to the exchange 406 until the contra-side trade order is no longer pending at the exchange 406.

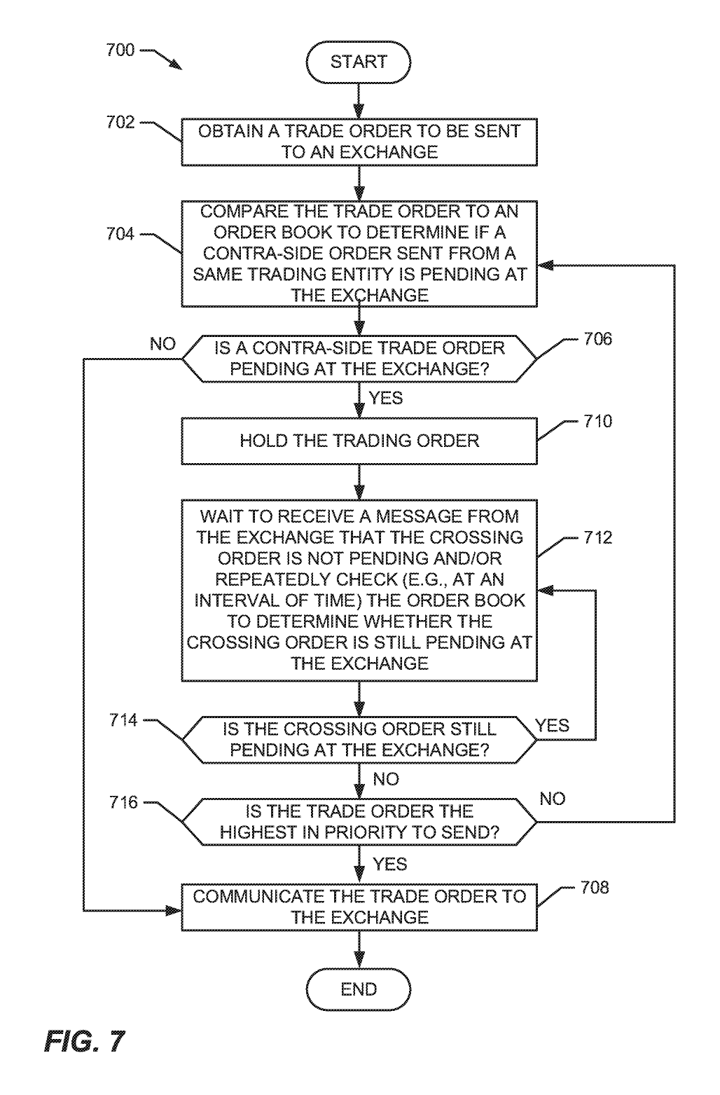

FIG. 7 illustrates a flow diagram representative of example process or method 700 to avoid orders that cross. The example method 700 may be implemented by the example submission manager 402 of the system 400 in FIG. 4. The example method 700 includes obtaining a trade order that is to be sent to an exchange (block 702). For example, in the system 400 of FIG. 4, the submission manager 402 may receive a trade order being communicated to the exchange 406 from the trading entity 404. The submission manager 402 may be implemented in a pre-trade risk module interposed between the trading entity 404 and the exchange 406.

The example method 700 includes comparing the trade order to one or more trade orders in an order book to determine if a contra-side (e.g., crossing) trade order sent from a same trading entity is pending at the exchange (block 704). The trading entity may be one or more traders and/or accounts (e.g., within a trading firm or financial institution) sharing a common order book. For example, in the system 400 of FIG. 4, the submission manager 402 includes the order book 408, which includes records of the trade orders that have been submitted to (and are pending) at the exchange 406. The submission manager 402 determines if there is a contra-side trade order pending (e.g., working). A contra-side or crossing trade order is a trade order for the same tradeable object at the same price. In some examples, a contra-side trade order may also include the same quantity as the new trade order.

The example method 700 of FIG. 7 includes determining if a contra-side trade order is pending at the exchange (block 706) (e.g., based on the comparison in block 704). If a contra-side trade order is not pending at the exchange, the example method 700 includes communicating the trade order to the exchange (block 708). If a contra-side trade order is detected, as determined in block 704, the example method 700 includes holding the trading order (block 710). For example, in the system 400 of FIG. 4, the submission manager 402 may hold a trade order and not release the trade order if a contra-side trade order is detected. In some examples, the submission manager 402 records the trade order in the order book 408. The record for the trade order may indicate the trade order is waiting.

The example method 700 includes waiting to receive a message or notice from the exchange that the contra-side trade order is no longer pending at the exchange and/or repeatedly checking the order book to determine whether the contra-side trade order is still pending at the exchange (block 712). In some examples, the submission manager 402 periodically (e.g., at a predetermined interval of time) checks the price level of the trade order to determine if the contra-side trade order is still pending (e.g., working or resting). Additionally or alternatively, the submission manager 402 may determine the contra-side trade order is no longer pending when a notice or message (e.g., a fill notice, a cancel notice, etc.) is received. The example method 700 includes determining whether the contra-side order is still pending at the exchange (block 714). If the contra-side trade order is still pending, the example method 700 continues to wait for a message from the exchange and/or periodically checks to determine the status of the contra-side trade order (block 712). If it is determined that the contra-side trade order is no longer pending at the exchange, the example method 700 includes determining whether the trade order is the highest trade order in a prioritized queue (block 716). For example, as shown in FIG. 6, the waiting trade orders may be prioritized in the auxiliary queue 410. The waiting trade orders may be prioritized based on date/time of when the respective orders were sent, the quantities of the respective orders, the accounts and/or traders associated with the respective orders, etc. If the trade order is the highest in the prioritized queue, the example method includes communicating the trade order to the exchange (block 708). Otherwise, the example method 700 begins again and the trade order is compared to the plurality of orders in the order book (block 704). Once the trade order is communicated to the exchange (block 708), the example method 700 ends.

For example, referring to FIGS. 4, 5 and 6, a user or trader associated with the trading entity 404 may submit a new trade order that is to be communicated to the exchange 406. The submission manager 402 obtains the trade order and determines if a contra-side trade order is pending at the exchange 406. For example, if the trade order is a sell order for the contract “ES Sep15” at a price of 2100.75 that is to be sent to the CME, the submission manager 402 may compare the trade order to the trade orders listed in the order book 408 to determine if a buy order (e.g., a contra-side trade order) for the contract “ES Sep15” at the price of 2100.75 at is pending at the exchange 406 (e.g., the CME). As shown in the top row of the example order book 408 in FIG. 5, a buy order for the contract “ES Sep15” at the price of 2100.75 is pending (e.g., “working”) at the CME. As a result, the submission manager 402 does not communicate the new trade order to the exchange 406. In some examples, the new trade order is recorded in the order book 408 (e.g., with a “waiting” status). If there are multiple trade orders that are withheld, the new trade order may be placed in the auxiliary queue 410, as shown in the example of FIG. 6. The submission manager 402 continues to monitor the status of the contra-side trade order and/or the price level of the trade order at the exchange 406 to determine when the contra-side trade order is no longer pending at the exchange 406. Once the contra-side trade order is filled, cancelled, or otherwise modified to remove the potential for crossing (e.g., based on a notice or message from the exchange 406), the submission manger 402 communicates the new trade order to the exchange 406. In the example of the FIG. 6, the trade orders in the auxiliary queue 410 are prioritized based on received date/time. Therefore, the oldest trade order (i.e., the trade order in the top row) is sent to the exchange 406 first, prior to the other trade orders in the auxiliary queue 410.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

For example, the example submission manager 402 of FIG. 4 and/or the example method 700 of FIG. 7 may be implemented by the trading application 330 of FIG. 3. For example, the example method 700 may be implemented as coded instructions (e.g., computer and/or machine readable instructions) for execution by the processor 312 as the trading application 330 and stored in the memory 314.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
obtaining, via a submission manager, a first trade order to be communicated to an exchange by a user associated with a trading entity, the first trade order corresponding to a tradeable object offered at the exchange;
comparing, via the submission manager, the first trade order to one or more trade orders in a submission record to determine whether a contra-side second trade order is included in the one or more trade orders of the submission record, wherein the second trade order was communicated to the exchange by the trading entity;
determining, via the submission manager, when the second trade order is no longer pending at the exchange; and
communicating, via the submission manager, the first trade order to the exchange in response to the determination that the second trade order is no longer pending at the exchange.

2. The method of claim 1, wherein the first trade order is one of an offer to buy or sell the tradeable object and the contra-side second trade order is the other of an offer to buy or sell the tradeable object at a same price level as the first trade order.

3. The method of claim 2, wherein the second trade order is for a same quantity of the tradeable object as the first trade order.

4. The method of claim 1, wherein determining when the second trade order is not pending at the exchange includes repeatedly determining a status of the second order in the submission record at a predetermined interval of time.

5. The method of claim 1, wherein determining when the second trade order is not pending at the exchange includes receiving a notice from the exchange indicating the second trade order has been filled at the exchange.

6. The method of claim 1, wherein the trading entity is a trading firm or financial institution or a trading group within a trading firm or financial institution.

7. The method of claim 1 further including recording the first trade order in the submission record in response to the determination that the second trade order is contra-side to the first trade order, the record of the first trade order including a status indicating the first trade order is waiting to be sent.

8. The method of claim 1, wherein the submission record includes a plurality of orders associated with the tradeable object waiting to be sent to the exchange, and wherein the plurality of orders are listed in a queue.

9. A system comprising a computing device configured to:
obtain a first trade order to be communicated to an exchange by a user associated with a trading entity, the first trade order corresponding to a tradeable object offered at the exchange;
compare the first trade order to one or more trade orders in a submission record to determine whether a contra-side second trade order is included in the one or more trade orders of the submission record, wherein the second trade order was communicated to the exchange by the trading entity;
determine when the second trade order is no longer pending at the exchange; and
communicate the first trade order to the exchange in response to the determination that the second trade is no longer pending at the exchange.

10. The system of claim 9, wherein the computing device is further configured to repeatedly determine a status of the second order in the submission record at a predetermined interval of time.

11. The system of claim 9, wherein the computing device is to determine the second trade order is no longer pending at the exchange based on a notice from the exchange indicating the second trade order has been filled at the exchange.

12. The system of claim 9, wherein the trading entity is a trading firm or financial institution or a trading group within a trading firm or financial institution.

13. The system of claim 9, wherein the computing device is further configured to record the first trade order in the submission record in response to the determination that the second trade order is contra-side to the first trade order, the record of the first trade order including a status indicating the first trade order is waiting to be sent.

14. The system of claim 9, wherein the submission record includes a plurality of orders associated with the tradeable object waiting to be sent to the exchange, and wherein the plurality of orders are listed in a queue.

15. A tangible computer-readable storage medium comprising instructions that, when executed, cause a computing device to at least:
obtain a first trade order to be communicated to an exchange by a user associated with a trading entity, the first trade order corresponding to a tradeable object offered at the exchange;
compare the first trade order to one or more trade orders in a submission record to determine whether a contra-side second trade order is included in the one or more trade orders of the submission record, wherein the second trade order was communicated to the exchange by the trading entity;
determine when the second trade order is no longer pending at the exchange; and
communicate the first trade order to the exchange in response to the determination that the second trade is no longer pending at the exchange.

16. The tangible computer-readable storage medium of claim 15, wherein the instructions further cause the computing device to repeatedly determine a status of the second order in the submission record at a predetermined interval of time.

17. The tangible computer-readable storage medium of claim 15, wherein the determination that the second trade order is no longer pending at the exchange is based on a notice from the exchange indicating the second trade order has been filled at the exchange.

18. The tangible computer-readable storage medium of claim 15, wherein the trading entity is a trading firm or financial institution or a trading group within a trading firm or financial institution.

19. The tangible computer-readable storage medium of claim 15, wherein the instructions further cause the computer device to record the first trade order in the submission record in response to the determination that the second trade order is contra-side to the first trade order, the record of the first trade order including a status indicating the first trade order is waiting to be sent.

20. The tangible computer-readable storage medium of claim 19, wherein the submission record includes a plurality of orders associated with the tradeable object waiting to be sent to the exchange, and wherein the plurality of orders are listed in a queue.
